(19) United States
(12) Patent Application Publication
(10) Pub. No.: US 2005/0035988 A1
(43) Pub. Date: Feb. 17, 2005

(54) Media transmission device, image output apparatus, and method for controlling transmission speed

(76) Inventors: Hsieh-Sheng Liao, Siluo Township (TW); Cheng-Lung Lee, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/909,982

(22) Filed: Aug. 3, 2004

(30) Foreign Application Priority Data
Aug. 12, 2003 (TW) 92122075

(51) Int. Cl. B41J 29/38

(52) U.S. Cl. 347/16; 347/9

(57) ABSTRACT

Media transmission device. The media transmission device is appropriate for an image output apparatus. The media transmission device has a media transmission unit, a temperature detector, and a controller. The temperature detector detects an ambient temperature before the media transmission unit transmits media and, according to the ambient temperature, outputs a temperature signal. The controller receives the temperature signal to control the transmission speed of the media transmission unit.

### BACKGROUND OF THE INVENTION

1. Field of the Invention

The present invention relates to a media transmission device, and particularly to an image output apparatus for changing the transmission speed by detecting an ambient temperature with a temperature detector before transmitting media.

2. Description of the Related Art

Typically, three types of paper, plain paper, coated paper, and photo paper are suitable for use by an ink-jet printer. Different types of paper have different characteristics including tenacity, thickness, and surface friction. A paper-loading device, driven by a motor within the inkjet printer, must adapt to different paper characteristics and be able to overcome resistance caused by a separator. When loading photo paper, the paper-loading device is driven by the motor with more torsion to overcome resistance than when loading plain paper, for achieving operation of paper-loading. Currently, inkjet printer motors provide high torsion at low speed and low torsion at high speed. There are three paper-loading methods. The first method provides torsion and speed based on paper thickness, wherein thinner paper is loaded at a higher speed, while thicker paper is loaded at lower speed. The second method depends on loading failure, wherein paper is reloaded at a low speed when a high speed loading fails. The third method combined with the first and second methods loads a variety of paper types at variable speed.

In practice, the ambient temperature is one of the factors causing failure of paper loading. It is not guaranteed that paper can be successfully loaded at low temperature with the speed which paper is successfully loaded at high temperature with. It is because that characteristics of paper vary at low temperature, so that paper has to be reloaded when paper with characteristics of large resistance at low temperature is not successfully loaded, increasing time cost for loading paper. Furthermore, the operation is interrupted in the case when it fails to load paper with the lowest speed.

### SUMMARY OF THE INVENTION

Therefore, an object of the present invention is to provide a media transmission device for changing a transmission speed according to an ambient temperature.

Another object of the present invention is to provide a method for controlling the transmission speed. The transmission speed of the image output apparatus varies according to a detected ambient temperature.

According to the objects described above, the present invention provides media transmission device. The media transmission device comprises a media transmission unit, a temperature detector, and a controller. The temperature detector detects an ambient temperature before the media transmission unit transmits media and, according to the ambient temperature, outputs a temperature signal. The controller receives the temperature signal to control the transmission speed of the media transmission unit.

The present invention further provides a method for controlling transmission speed. First, the temperature detector detects an ambient temperature before the media transmission unit transmits media. The controller determines whether the ambient temperature is higher than a predetermined temperature. If so, the controller directs the media transmission unit to transmit at a first speed, and if not, at a second speed.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram of media transmission device appropriate for an image output apparatus of the present invention.

FIG. 2 is a block diagram of an inkjet image output apparatus 24 of the present invention.

FIG. 3 is a flowchart of a method for controlling the paper-loading speed of the present invention.

FIG. 4 is a flowchart of a method for controlling the paper-output speed of the present invention.

### DETAILED DESCRIPTION OF THE INVENTION

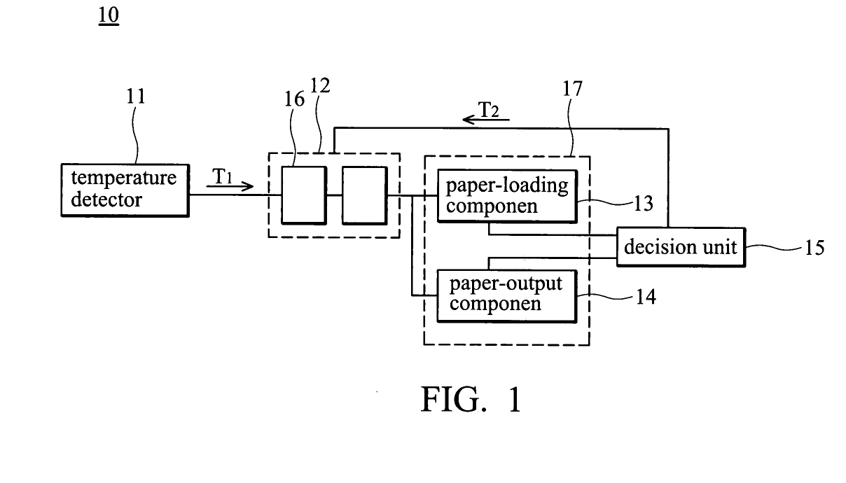

FIG. 1 is a block diagram of media transmission device 10 appropriate for an image output apparatus of the present invention. The media transmission device 10 comprises a temperature detector 11, a controller 12, a decision unit 15, and a media transmission unit 17. The media transmission unit 17 has a paper-loading component 13 and a paper-output component 14.

The paper-loading component 13 is disposed at a media input area inside the image output apparatus. The paper-loading component 13 transmits the media from a media storage to a printing area inside the image output apparatus. In the embodiment, the media is paper. Before the paper-loading component 13 loads the paper, the temperature detector 11 detects the ambient temperature and outputs a temperature signal T1 according to the ambient temperature. Moreover, the temperature signal T1 is either an analog voltage signal or a current signal. The controller 12 receives the temperature signal T1 and directs the paper-loading speed of the paper-loading component 13 according to the temperature signal T1. When the ambient temperature is higher than a predetermined temperature, the controller 12 directs the paper-loading component 13 to load paper at a first speed. When the ambient temperature is lower than or equal to the predetermined temperature, the controller 12 directs the paper-loading component 13 to load paper at a second speed lower than the first speed. The decision unit 15 determines whether the paper-loading component 13 was successful. If the paper-loading component 13 fails, the decision unit 15 outputs a decision signal T2 to the controller 12, and the controller 12 then directs the paper-loading component 13 to load paper at a third speed.

Furthermore, the paper-output component 14 is disposed in a media output area inside the image output apparatus. The paper-output component 14 transmits the media from the printing area to an output end inside the image output apparatus. After receiving the temperature signal T1, the controller 12 directs the paper-output speed of the paper-output component 14 according to the temperature signal T1. When the ambient temperature is higher than the predetermined temperature, the controller 12 directs the paper-output component 14 to output paper at a fourth speed. When the ambient temperature is lower than or equal to the predetermined temperature, the controller 12 directs the paper-output component 14 to output paper at a fifth speed lower than the fourth speed. Finally, the decision unit 15 determines whether the paper-output component 14 is successful. If the paper-output component 14 fails, the decision unit 15 outputs the decision signal T2 to the controller 12, and the controller 12 then directs the paper-output component 14 to output paper at a sixth speed. In the embodiment, the third speed is lower than both the first speed and the second speed, while the sixth speed is lower than both the fourth speed and the fifth speed.

The controller 12 of the embodiment according to the present invention comprises an analog to digital converter 16. The temperature signal T1 converted by the analog-to-digital converter 16 is able to control the paper-loading component 13 and the paper-output component 14 respectively to load and output paper. The temperature detector 11 comprises a temperature detection element, such as a thermistor, a thermocouple, a platinum resistance thermometer, or an infrared thermometer.

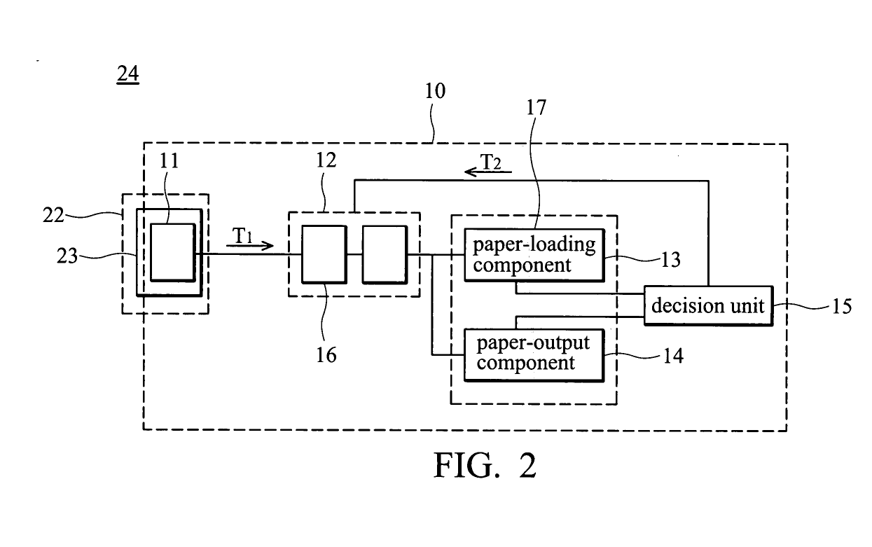

FIG. 2 is a block diagram of an inkjet image output apparatus 24 of the present invention. The inkjet image output apparatus 24 has a cartridge 22 and the media transmission device 10. The temperature detector 11, the controller 12, the decision unit 15, and the media transmission unit 17 operate in the same manner as previously described. Additionally, a print head chip 23 is disposed on a print head within the cartridge 22. The temperature detector 21 appropriate for the inkjet image output apparatus 24 is disposed on the print head chip 23.

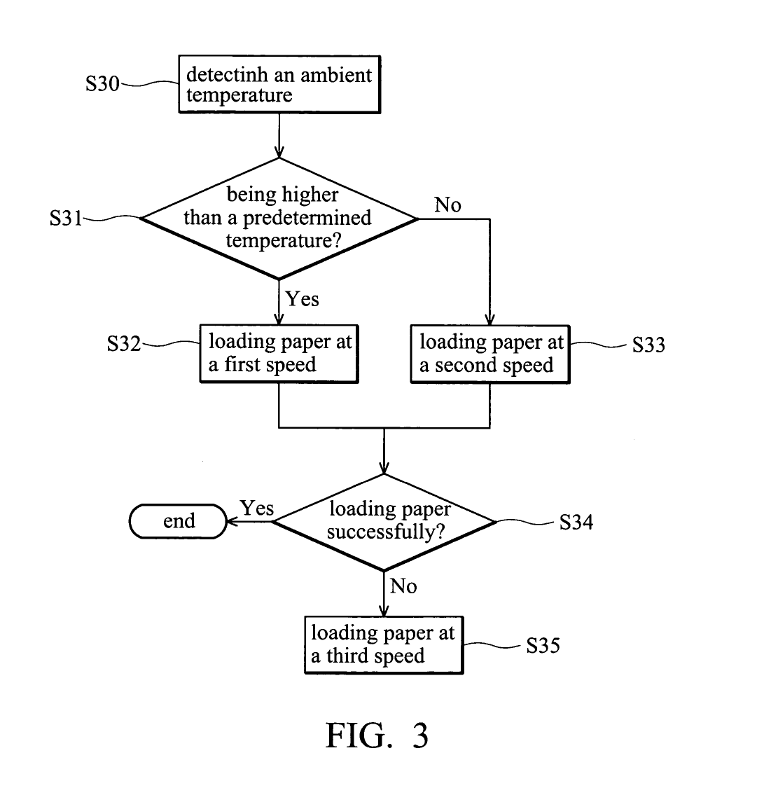

FIG. 3 is a flowchart of a method for controlling the paper-loading speed of the present invention. The method is appropriate for the image output apparatus shown in FIG. 2. When the image output apparatus is in paper-loading mode, before the paper-loading component 13 loads paper, the temperature detector 11 detects the ambient temperature (step S30), and the controller 12 determines whether the ambient temperature is higher than the predetermined temperature (step S31). When the ambient temperature is higher than the predetermined temperature, the controller 12 directs the paper-loading component 13 to load paper at the first speed (step S32). When the ambient temperature is lower than or equal to the predetermined temperature, the controller 12 directs the paper-loading component 13 to load paper at the second speed (step S33). Finally, the decision unit 15 determines whether the paper-loading component 13 is successful (step S34). If not, the paper-loading component 13 loads paper at the third speed (step S35).

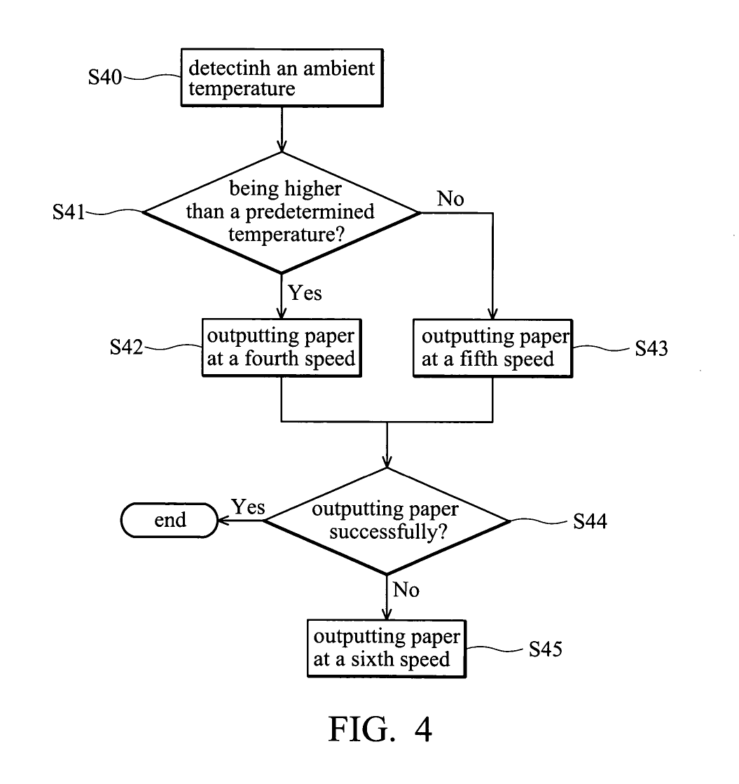

FIG. 4 is a flowchart of the method of the present invention for controlling paper-output speed. When the image output apparatus is in paper-output mode, before the paper-output component 14 outputs paper, the temperature detector 11 detects the ambient temperature (step S40), and the controller 12 determines whether the ambient temperature is higher than the predetermined temperature (step S31). When the ambient temperature is higher than the predetermined temperature, the controller 12 directs the paper-output component 14 to output paper at the fourth speed (step S42). When the ambient temperature is lower than or equal to the predetermined temperature, the controller 12 directs the paper-output component 14 to output paper at the fifth speed (step S43). Finally, the decision unit 15 determines whether the paper-output component 14 is successful (step S44). If not, the paper-output component 14 outputs paper at the sixth speed (step S45).

Paper is introduced hereinabove to exemplify media used by the present invention and in practice can be replaced by other materials including transparencies. The paper-loading component 13 and the paper-output component 14 make up the media transmission unit 17. According to the mode of the image output apparatus, the media transmission unit 17 either loads or outputs paper.

The media transmission device of the invention changes the paper-loading speed and the paper-output speed according to the ambient temperature. It is possible to prevent failure caused by changes in media characteristics at different temperatures. Table 1 shows the amount of paper loaded and output by the media transmission device at 10 and 23 degrees centigrade respectively.

| | | 10° C. | 23° C. | |
|---|---|---|---|---|
| Loading paper | plain paper | 8 ips | 8.8 | ips |
| | photo paper | 2 ips | 5 | ips |
| Outputting paper | plain paper | 10 ips | 11.2 | ips |
| | photo paper | 10 ips | 11.2 | ips |

While the present invention has been described by way of example and in terms of the preferred embodiments, it is to be understood that the present invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A media transmission device for transmitting media in an image output apparatus, comprising:
a media transmission unit for transmitting the media from a first position to a second position at a transmission speed;
a temperature detector for detecting an ambient temperature and outputting a temperature signal according to the ambient temperature; and
a controller for receiving the temperature signal and adjusting the transmission speed of the media transmission unit according to the temperature signal.

2. The media transmission device as claimed in claim 1, wherein the media transmission unit transmits the media at a first speed when the ambient temperature is higher than a predetermined temperature or at a second speed when the ambient temperature is lower than or equal to the predetermined temperature.

3. The media transmission device as claimed in claim 2, wherein the second speed is lower than the first speed.

4. The media transmission device as claimed in claim 1, wherein the temperature detector comprises a thermistor, a thermocouple, a platinum resistance thermometer, or an infrared thermometer.

5. The media transmission device as claimed in claim 1, wherein if the media transmission unit is disposed at a media input area inside the image output apparatus, the first position is at a media storage inside the image output apparatus, and the second position is at a printing area inside the image output apparatus.

6. The media transmission device as claimed in claim 1, wherein if the media transmission unit is disposed in a media output area inside the image output apparatus, the first position is at a printing area inside the image output apparatus, and the second position is at an output end inside the image output apparatus.

7. The media transmission device as claimed in claim 1 further comprising a decision unit 15 to output a decision signal to the controller when the media transmission unit fails, wherein the controller 12 directs the media transmission unit to transmit the media at a third speed lower than both the first speed and the second speed.

8. An image output apparatus comprising:
a body;
a print head disposed inside the body;
a media transmission unit for transmitting the media from a first position to a second position at a transmission speed;
a temperature detector, disposed on the print head, for detecting an ambient temperature before the media transmission unit transmits the media and outputting a temperature signal according to the ambient temperature; and
a controller for receiving the temperature signal and adjusting the transmission speed of the media transmission unit according to the temperature signal.

9. The image output apparatus as claimed in claim 8, wherein the media transmission unit transmits the media at a first speed when the ambient temperature is higher than a predetermined temperature or at a second speed when the ambient temperature is lower than or equal to the predetermined temperature.

10. The image output apparatus as claimed in claim 9, wherein the second speed is lower than the first speed.

11. The image output apparatus as claimed in claim 8, wherein the temperature detector comprises a thermistor, a thermocouple, a platinum resistance thermometer, or an infrared thermometer.

12. The image output apparatus as claimed in claim 8, wherein if the media transmission unit is disposed at a media input area inside the image output apparatus, the first position is at a media storage inside the image output apparatus, and the second position is at a printing area inside the image output apparatus.

13. The image output apparatus as claimed in claim 8, wherein if the media transmission unit is disposed in a media output area inside the image output apparatus, the first position is at a printing area inside the image output apparatus, and the second position is at an output end inside the image output apparatus.

14. The image output apparatus as claimed in claim 8 further comprising a decision unit to output a decision signal to the controller when the media transmission unit fails to load paper, wherein the controller 12 directs the media transmission unit to transmit the media at a third speed lower than both the first speed and the second speed.

15. A method for controlling transmission speed, appropriate for an image output apparatus having a media transmission unit, comprising the steps of:
detecting an ambient temperature before the media transmission unit transmits media to output images;
deciding whether the ambient temperature is higher than a predetermined temperature; and
transmitting the media from a first position to a second position at a first speed when the ambient temperature is higher than the predetermined temperature or at a second speed when the ambient temperature is lower than or equal to the predetermined temperature, wherein the second speed is lower than the first speed.

16. The method for controlling transmission speed as claimed in claim 15, wherein the detection step further comprises a step of providing a temperature detector for detecting the ambient temperature and, according to the ambient temperature, outputting a temperature signal.

17. The method for controlling transmission speed as claimed in claim 16, wherein the temperature detector comprises a thermistor, a thermocouple, a platinum resistance thermometer, or an infrared thermometer.

18. The method for controlling transmission speed as claimed in claim 15, wherein if the media transmission unit is disposed at a media input area inside the image output apparatus, the first position is at a media storage inside the image output apparatus, and the second position is at a printing area inside the image output apparatus.

19. The method for controlling transmission speed as claimed in claim 15, wherein if the media transmission unit is disposed in a media output area inside the image output apparatus, the first position is at a printing area inside the image output apparatus, and the second position is at an output end inside the image output apparatus.

20. The method for controlling transmission speed as claimed in claim 15 further comprising steps of:
determining whether the media transmission unit transmits the media successfully; and
transmitting the media at a third speed if the media transmission unit fails to transmit the media.

21. The method for controlling transmission speed as claimed in claim 20, wherein the third speed is lower than both the first speed and the second speed.

22. The method for controlling transmission speed as claimed in claim 20, wherein the determining step further comprises a step of providing a decision unit for deciding whether the media transmission unit transmits the media successfully.
